(19) United States
(12) Patent Application Publication
(10) Pub. No.: US 2006/0187133 A1
(43) Pub. Date: Aug. 24, 2006

(54) Antenna structure for wave timepiece, and wave timepiece having the antenna structure

(76) Inventor: Akihiro Matoge, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/353,616

(22) Filed: Feb. 14, 2006

(30) Foreign Application Priority Data
Feb. 21, 2005 (JP) 2005-043304

(51) Int. Cl. H01Q 9/00

(52) U.S. Cl. 343/745

(57) ABSTRACT

An antenna structure for wave timepiece that can be easily and securely tuned even in a narrow, planar layout space and a wave timepiece having the antenna structure are provided. In an antenna structure of a wave timepiece, a condenser that performs tuning in cooperation with a coil of an antenna body is mounted on both of a surface and a back of a lead board disposed near a terminal of the antenna body. A condenser for coarse adjustment is mounted at a side of back of the lead board, and a condenser for fine adjustment is mounted at a side of surface. The lead board comprises a thick and rigid board, and condensers at the sides of the surface and the back are disposed in positions that are overlapped in a thickness direction of the board. An antenna frame for receiving the antenna body has a recess in an end, and the condenser at the side of the back is received in the recess.

### BACKGROUND OF THE INVENTION

1. Field of the Invention

The present invention relates to an antenna structure for wave timepiece, and more particularly, an antenna structure suitable for use in a small-size wave timepiece such as watch-type wave timepiece.

2. Description of the Prior Art

A wave timepiece receives a standard wave including time information, and corrects time of an internal timepiece according to the time information (JP-A-2005-30910). Currently, sending stations of standard wave exist at two places in Japan. The two standard waves have different frequencies, 40 kHz and 60 kHz respectively. Therefore, the wave timepiece is configured such that it can be tuned to either of frequencies. Since an antenna of the wave timepiece comprises a coil having a magnetic core, a resonance (tuning) circuit has a condenser for tuning having a capacitance that has been adjusted to have capacitance corresponding to a frequency of the standard wave to be resonated depending on inductance of the coil, so that tuning is carried out. The tuning condenser is disposed at a terminal (antenna output terminal) of a winding wire of the coil.

In the watch type wave timepiece, the antenna is limited in size because a case is limited in size, therefore a layout space for the condenser for tuning is small. On the other hand, since size of the antenna is small, when an electric wave is comparatively weak, reception output of the antenna tends to be weak. In order to securely extract the time information from the comparatively weak wave signal, a tuning circuit comprising the antenna and the condenser is required to be accurately tuned for improving reception sensitivity, and capacitance of the condenser is determined at accuracy of about several tens microfarads or less. However, since the capacitance of about several tens microfarads may depend on various types of stray capacitance due to variation for each of antennas or layout environment of the antenna (types or layouts and the like of various timepiece components disposed in the periphery of the antenna), it may be different for each of individuals. On the other hand, since condensers that are normally provided have discontinuous levels of capacitance, the circuit needs to be tuned by using a combination of several condensers for each of the individuals.

Therefore, in the watch type wave timepiece, it is necessary that adjustment and assembly are finally performed by mounting the several condensers on a lead -board arranged near a terminal of the coil in a different combination for each of individuals.

However, as described before, in a small-size wave timepiece such as the watch-type wave timepiece, the number of mountable condensers is small because of the limited space, consequently desired tuning can not be easily achieved.

While it was tried that a trimmer condenser was prepared for appropriate trimming to perform tuning, it was not practical because a large, planar space was required for arranging the trimmer condenser.

The invention, which was made in the light of the points, aims to provide an antenna structure for wave timepiece that can be easily and securely tuned even in a narrow, planar layout space-and a wave timepiece having the antenna structure.

### SUMMARY OF THE INVENTION

To achieve the object, in the antenna for wave timepiece of the invention, condensers that perform tuning in cooperation with a coil of an antenna body are mounted on both of a surface and a back of a lead board disposed near a terminal of the antenna body.

In the antenna structure for wave timepiece of the invention, since the condensers for tuning are mounted not only on the surface of the lead board, but also on the back, a space in which the condensers can be mounted is doubled, therefore many condensers can be disposed. Moreover, in the antenna structure for wave timepiece of the invention, since area per one face of the lead board can be reduced, area of a surface of a board for mounting the condenser for tuning can be reduced, therefore at least one of length and width of the board can be shortened.

In this case, a condenser that is practically necessary has been disposed at a back side, and a condenser in correspondence with a capacitance level for tuning that depends on individual difference is disposed at a surface side, thereby tuning can be actually performed by using only the surface side.

Therefore, in the antenna structure of the invention, typically, a condenser having a capacitance as a reference that is predictable from a resonance (tuning) frequency and inductance of the antenna body (however, actually, a condenser typically having capacitance at a lower limit or capacitance at an upper limit in consideration of variation of inductance and the like during manufacturing) is mounted at the back side of the lead board as a condenser for coarse adjustment, and depending on variation, a condenser for fine adjustment is mounted at the surface side of the lead board. Since the condenser for fine adjustment is mounted at the surface side, it can be replaced to obtain an optimum tuning condition while a resonance (tuning) condition or a reception condition is confirmed.

In the antenna structure of the invention, typically, the lead board comprises a thick board, and the condensers at the surface and backsides are disposed in positions overlapped in a thickness direction of the board. Aboard having excellent heat resistance is used for the thick board such that the condensers can be disposed on the surface and back of the board in the positions overlapped in the thickness direction of the board, and typically an epoxy board reinforced by incorporating glass fiber (hereinafter, referred to as “glass-epoxy board”) is used. However, a board mainly comprising phenol resin and the like can be also used. In this case, through holes and the like including a conductor for conducting between two sides of the thick board are provided in the board, thereby the condensers are easy to be disposed effectively on the surface and the back depending on positions for each of several resonance frequencies, and the area to be occupied by the board can be controlled to a minimum.

In the antenna structure for wave timepiece of the invention, typically, an antenna frame for receiving the antenna body has a recess at an end, and a condenser at the back side is received in the recess. In this case, since the condenser mounted at the backside can be situated in the recess, a volume region that has been a support stage for setting and adhering the board in a conventional layout can be effectively used, in addition, even if the condensers are disposed on both faces, a space to be occupied by the condensers can be controlled to a practically similar level.

Since a wave timepiece having the antenna structure as above is small and can be tuned to frequencies of several standard waves at high sensibility, it can receive each of the several standard waves at high sensitivity, time can be corrected surely in a wide area.

### BRIEF DESCRIPTION OF THE SEVERAL VIEWS OF THE DRAWINGS

A preferred form of the present invention is illustrated in the accompanying drawings in which:

FIG. 1 are views showing a body of a wave timepiece having an antenna structure of a preferred example according to the invention, wherein FIG. 1A is a plane, explanatory drawing (which shows a type that can resonate with- three frequencies as shown in FIG. 4A and FIG. 4B), and FIG. 1B is a side, explanatory drawing when FIG. 1A is seen in a direction of an arrow 1B;

FIG. 2 are views showing a portion of a circuit for resonance of the antenna structure in an expanded and schematic manner, wherein FIG. 2A is a partial fracture, section explanatory-drawing of FIG. 1A (which shows a type that can resonate with two frequencies as shown in FIG. 3A and FIG. 3B, as a circuit for resonance), and FIG. 2B is a section, explanatory drawing similar to FIG. 2A of a portion of a conventional circuit for resonance;

FIG. 3 are views showing a circuit for resonance that can resonate with two frequencies, wherein FIG. 3A and FIG. 3B correspond to the preferred example according to the invention for realizing a circuit of FIG. 3C, and FIG. 3D corresponds to a conventional example, and FIG. 3A is a plane, explanatory drawing of a surface side of a board, FIG. 3B is a plane, explanatory drawing of a back side of the board of FIG. 3A, FIG. 3C is a schematic circuit diagram for resonance realized by FIG. 3A and FIG. 3B, and FIG. 3D is a plane, explanatory drawing similar to FIG. 3A of a conventional board;

FIG. 4 are views showing a circuit for resonance that can resonate with three frequencies, wherein FIG. 4A is a plane, explanatory drawing similar to FIG. 3A, FIG. 4B is a plane, explanatory drawing similar to FIG. 3B of a back side of the board of FIG. 4A, FIG. 4C is a schematic circuit diagram for resonance realized by FIG. 4A and FIG. 4B, and FIG. 4D is a plane, explanatory drawing similar to FIG. 4A of a conventional board; and

FIG. 5 show schematic graphs for illustrating a characteristic of the antenna structure, wherein FIG. 5A is a graph showing dependence of antenna sensitivity (dB) on antenna length, and FIG. 5B is a graph showing a relation between capacitance near a resonance value and resonance output.

### DETAILED DESCRIPTION OF THE PREFERRED EMBODIMENTS

Next, a preferred embodiment of the invention will be described according to a preferred example as shown in accompanying drawings.

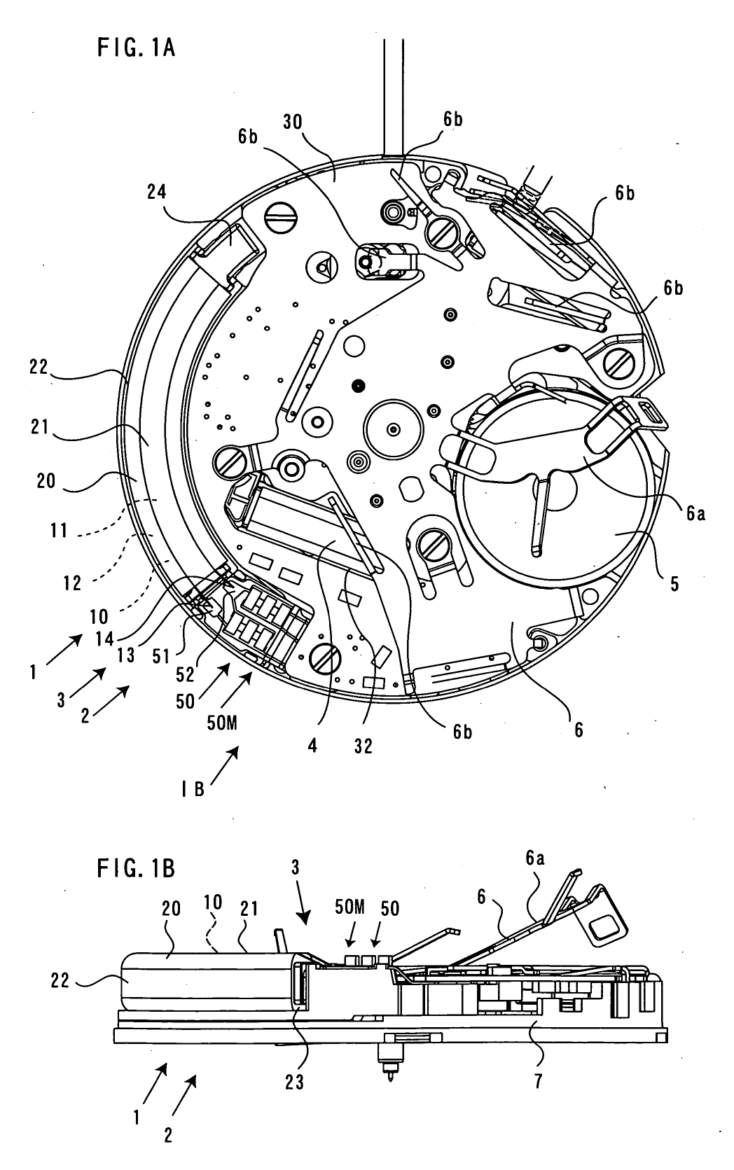

FIGS. 1 show a body or timepiece body 2 configuring a watch-type wave timepiece 1 of a preferred example according to the invention.

The wave timepiece 1 has an arcuately extended, antenna structure 3 near the outer circumference of the timepiece situated close to the inner circumference of a case (not shown) The antenna structure 3 has an arcuate magnetic-core 11 comprising a soft magnetic-material such as ferrite, an antenna body 10 comprising a winding wire 12 for the core, an antenna frame 20 covering the antenna body 10, and a circuit for tuning 50.

A circuit board 30 for a timepiece body configuring a circuit block mainly for the timepiece body is disposed in a region other than the antenna structure 3. In this example, the circuit board 30 extends in an approximately circular pattern over approximately all of the timepiece body 2 except for an arcuate cutout 31 corresponding to the antenna 3 and a cutout or an opening 32 corresponding to a motor 4 and the like. On the circuit board 30, for example, an IC (integrated circuit) (not shown) for receiving an electric wave is mounted in addition to a main IC (not shown) associated with a timepiece function.

A battery 5 is disposed at a side opposite in a diameter direction to a region where the antenna structure 3 exists in the timepiece body 2, and a contact 6a that contacts to a cathode of the battery 5 is provided, and a battery positive terminal 6 that provides reference potential to various circuit components at respective contacts 6b extends over a large area of the timepiece body 2. The timepiece components are set or fixed directly on indirectly on a base plate 7 as a base of the timepiece body 2.

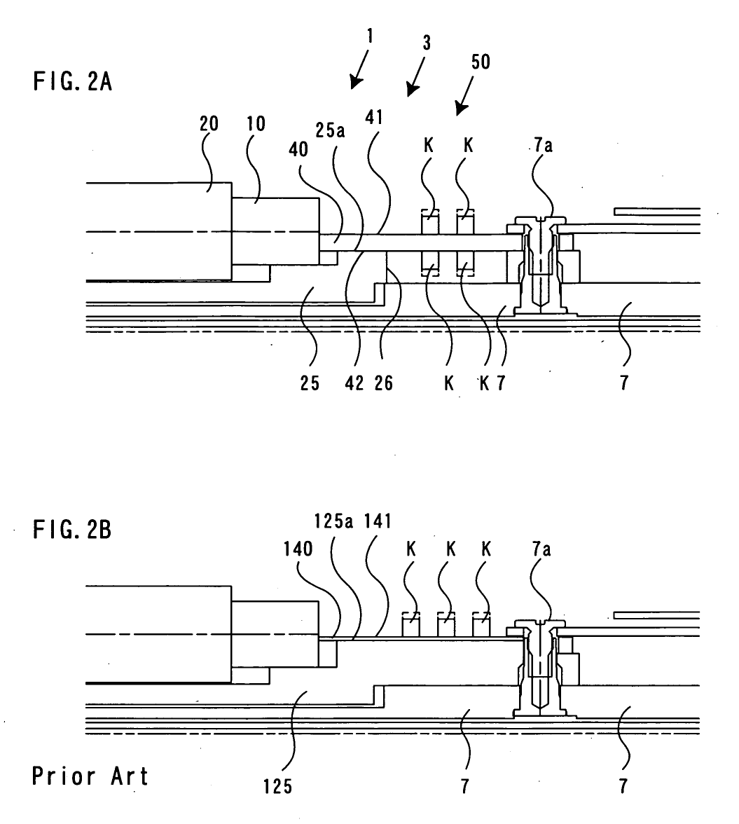

The antenna frame 20 includes a portion 21 situated at a back cover side of the antenna body 10, and a portion 22 situated at on outer circumferential side and a portion 23 situated at a side of the base plate 7. The portion 23 situated at the side of the base plate 7 has extending portions 24., 25 at two ends along a circular arc, and as seen from FIG. 2A, a recess 26 is formed in one extending portion 25.

A circuit for tuning 50 is formed on the extending portion 25 of the antenna frame 20. The circuit for tuning 50 includes a glass-epoxy board 40 set on the extending portion 25, which is comparatively thick, heat-resistant, and rigid. The glass-epoxy board 40 is fixed to the base plate 7 by a setscrew 7a together with the extending portion 25 of the antenna frame 20. On the glass-epoxy board 40, several condensers K are mounted on both of a face at a surface side (surface, or a face at the back cover side) 41 and a face at a back side (back, or a face at the side of the base plate 7) 42.

Here, in an arranged condition of the glass-epoxy board 40, the board is contacted to and supported by an opposing surface portion 25a on the periphery of the recess 26 in the extending portion 25 in an outer circumferential portion, and the condensers K mounted at a back side 42 are fit in the recess 26 and received therein.

From an end at the side where the extending portion 25 exists in the antenna frame 20, both end lead lines 13, 14 (FIG. 1A) as output terminals of the winding wire 12 of the antenna body 10 are led out to the outside of the antenna frame 20, and connected to wiring patterns for input terminal 51, 52 formed on the glass-epoxy board 40 in the circuit for tuning 50.

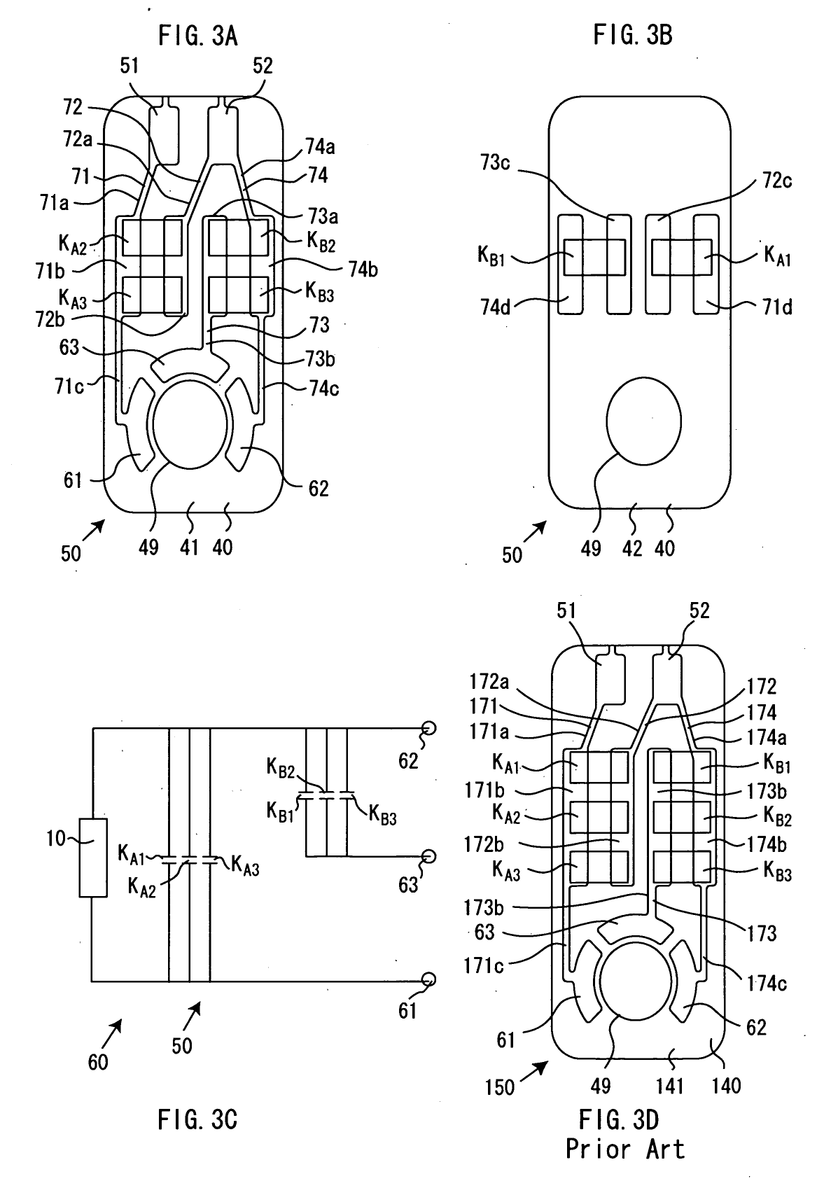

More specifically, a tuning or resonance circuit 60 including the circuit for tuning 50 schematically has a configuration, for example, as shown in FIG. 3C. The resonance circuit 60 comprises inductance L comprising an input-terminal antenna body 10 and the circuit for tuning 50. In the antenna body 10 of the watch type wave timepiece 1, the inductance L is, for example, about 15 mH to 20 mH in level. The circuit for tuning 50 has condensers K_{A1}, K_{A2} and K_{A3} (when a group of the condensers are generally called, they are expressed by a sign K_{A}) having capacitance of C_{A1}, C_{A2}, and C_{A3}, and condensers K_{B1}, K_{B2} and K_{B3} (when a group of the condensers are generally called, they are expressed by a sign K_{B}) having capacitance of C_{B1}, C_{B2} and C_{B3}, in parallel respectively. When condensers K_{A} and K_{B} are generally called, or not distinguished from each other, a sign K is used. In the resonance circuit 60, resonance output for a standard wave E1 having a first transmission frequency f1 is extracted between terminals 61 and 62, and resonance output for a standard wave E2 having a second transmission frequency f2 is extracted between terminals 61 and 63. Here, it is assumed that regarding the condenser group K_{A}, capacitance satisfies a relationship of C_{A1}>C_{A2}>C_{A3}, and the group of condensers K_{B} satisfies a capacitance relationship of C_{B1}>C_{B2}>C_{B3}. When a standard wave in a mode of a long wave has a frequency of about 40 kHz, capacitance of the condenser for tuning as a whole is about 750 to 850 pF. The frequency of the standard wave to be tuned, the inductance of the coil, and the capacitance may have different values.

A resonance circuit 60 including the circuit for tuning 50 of an example of the invention as shown in FIG. 2A and FIGS. 3A and B, which is for realizing the resonance circuit 60 schematically shown in FIG. 3C, is described in detail; and before that, a construction of a conventional resonance circuit 160 including a conventional circuit for tuning 150 is described in detail according to FIG. 2B and FIG. 3D. Conventional members or elements which correspond to those of the example of the invention but include different portions are marked with signs that are added with 1 to the hundreds digit of signs of those of the example. Completely identical members or elements are marked with identical signs.

In the conventional circuit for resonance 150, a board 140 comprises a thin, flexible board, and the flexible board 140 is set on a surface 125a of an extending portion 125 of an antenna frame 120 and adhered thereto, and fixed to a base plate 7 by a setscrew 7a together with the extending portion 125. The extending portion 125 is thick, and does not have a recess as the recess 26 and is solid; and all the condensers K are mounted on a surface (side face of a back cover) 141 of the flexible board 140.

In a conventional antenna structure 103 in which the condensers K are mounted only at a side of the surface 141 in this way, the condensers K are disposed and mounted as shown in FIG. 3D. That is, the flexible board 140 has contacts 51, 52 connected to output terminals 13, 14 of a winding wire 12 of an antenna body 10, a surface wiring line 171 extending from the contact 51 to a contact at an output side 61, a surface wiring line 172 that is located near the wiring line 171 and extends from the contact 52 to the halfway point approximately parallel to the wiring line 171, a surface wiring line 173 that is located near the wiring line 172 and extends from the halfway point to a contact at the output side 63 approximately parallel to the wiring line 172, and a surface wiring line 174 that is located near the wiring line 173 and extends from the contact 52 to a contact at the output side 62 approximately parallel to the wiring line 173. 49 is a hole for inserting the setscrew 7a.

The wiring line 171 has elongated wiring portions 171a, 171c and a long and wide, contact formation part 171b between them; the wiring line 172 has an elongated wiring portion 172a and a long and wide, contact formation part 172b; the wiring line 173 has a long and wide, contact formation part. 173a and an elongated wiring portion 173b; and the wiring line 174 has elongated wiring portions 174a, 174c and a long and wide, contact formation part 174b between them.

The long contact formation parts 171b and 172b are formed oppositely and parallel to each other, and condensers K_{A1}, K_{A2} and K_{A3} are mounted between the two contact formation parts 171b and 172b. Since all the condensers K_{A1}, K_{A2} and K_{A3} that belong to the condenser group K_{A} are mounted at the side of the surface 141 between the contact formation parts 171b and 172b, length of the contact formation parts 171b and 172b is increased, consequently length of the flexible board 140 is increased.

Similarly, the long contact formation parts 173a and 174b are formed oppositely and parallel to each other, and condensers K_{B1}, K_{B2} and K_{B3} are mounted between the two contact formation parts 173a and 174b. Since all the condensers K_{B1}, K_{B2} and K_{B3} that belong to the condenser group K_{B} are mounted at the side of the surface 141 between the contact formation parts 173a and 174b, again in this case, length of the contact formation parts 173a and 174b is increased, consequently length of the flexible board 140 is increased.

On the other hand, in the antenna structure of the example of the invention, as shown in FIG. 3A, at the side of the surface 41 of the glass-epoxy board 40, contacts 51, 52 to be connected to output terminals 13, 14 of the winding wire 12 of the antenna body 10 are formed; and a surface wiring line 71 extending from a contact 51 to a contact at an output side 61, a surface wiring line 72 that is located near the wiring line 71 and extends from a contact 52 to the halfway point approximately parallel to the wiring line 71, a surface wiring line 73 that is located near the wiring line 72 and extends from the halfway point to a contact at the output side 63 approximately parallel to the wiring line 72, and a surface wiring line 74 that is located near the wiring line 73 and extends from the contact 52 to a contact at the output side 62 approximately parallel to the wiring line 73 are formed.

The wiring line 71 has elongated wiring portions 71a, 71c and a short and wide, contact formation part 71b between them; the wiring line 72 has an elongated wiring portion 72a and a short and wide, contact formation part 72b; the wiring line 73 has a short and wide, contact formation part 73a and an elongated wiring portion 73b; and the wiring line 74 has elongated wiring portions 74a, 74c and a short and wide, contact formation part 74b between them.

In the above, the wiring lines 71, 72, 73 and 74 have the same configurations as those of the wiring lines 171, 172, 173 and 174 except that length of the contact formation parts 71b, 72b, 73a and 74b is smaller than that of the contact formation parts 171b, 172b, 173a and 174b.

The short contact formation parts 71b and 72b are formed oppositely and parallel to each other, and only condensers K_{A2} and K_{A3} having small capacitance in the condenser group K_{A} are mounted between both the contact formation parts 71b and 72b. That is, since only the condensers K_{A2} and K_{A3} as part of the condensers K_{A1}, K_{A2} and K_{A3} that belong to the condenser group K_{A} are mounted at the side of the surface 41 between the contact formation parts 71b and 72b, length of the contact formation parts 71b and 72b is decreased, consequently length of the board 40 is decreased compared with that of the board 140. Moreover, since the condenser K_{A1}, which have large capacity and tends to be increased in size, can be reduced from the surface side, reduction in size can be designed at the surface side in a degree beyond a ratio of the number of condensers.

Similarly, the short contact formation parts 73a and 74b are formed oppositely and parallel to each other, and only condensers K_{B2} and K_{B3} having small capacitance in the condenser group K_{B} are mounted between both the contact formation parts 73a and 74b. Similarly in this case, only the condensers K_{B2} and K_{B3} as part of the condensers K_{B1}, K_{B2} and K_{B3} that belong to the condenser group K_{B} are mounted at the side of the surface 141 between the contact formation parts 73a and 74b, therefore length of the contact formation parts 73a and 74b is decreased again in this case, consequently length of the board 40 is decreased compared with that of the board 140.

As shown in FIG. 3B, at the side of the back 42 of the board 40, the contact formation parts 71d, 72c, 73c and 74d having the substantially same shapes as those of the contact formation parts 71b, 72b, 73a and 74b are further formed in positions at which they are overlapped with the contact formation parts 71b, 72b, 73a and 74b respectively. Respective contact formation parts 71d, 72c, 73c and 74d are conducted with respective contact formation parts 71b, 72b, 73a and 74b situated at an opposite side via through-holes (not shown).

At the side of the back 42, between the contact formation parts 71d and 72c, the condenser K_{A1} having maximum capacitance C_{A1} that belongs to the condenser group K_{A} is connected in parallel with the condensers K_{A2} and K_{A3} having small capacitance in the group K_{A} which are situated at the side of the surface 41, and between the contact formation parts 73c and 74d, the condenser K_{B1} having maximum capacitance C_{B1} that belongs to the condenser group K_{B} is connected in parallel with the condensers K_{B2} and K_{B3} having small capacitance in the group K_{B} which are situated at the side of the surface 41.

Here, the condensers K_{A1} and K_{B1} mounted at the side of the back 42 are condensers which have maximum capacitance in respective groups K_{A} and K_{B}, and when a rough level of the inductance L is determined depending on a shape, size, or material of the antenna body 10, a rough level of the maximum capacitance can be practically predicted depending on a resonance frequency f corresponding to a transmission frequency of a standard wave. Since the condensers K_{A1} and K_{B1} having the maximum capacitance can function as the condensers for coarse adjustment for resonance, even if the condensers have been previously arranged at the back side, and then the board 40 is fixed in a predetermined position on the extending portion 25, fine adjustment of capacitance for accurate resonance is not hindered. As described before, since the condensers for coarse adjustment K_{A1}, K_{B1} situated at the side of the back 42 can be received in the recess 26 of the extending portion 25, presence of the condensers at the back side K_{A1}, K_{B1} may not cause increase in thickness of the timepiece body 2. While each of the condensers for coarse adjustment is provided singly in this example, the condensers may be provided plurally in some cases.

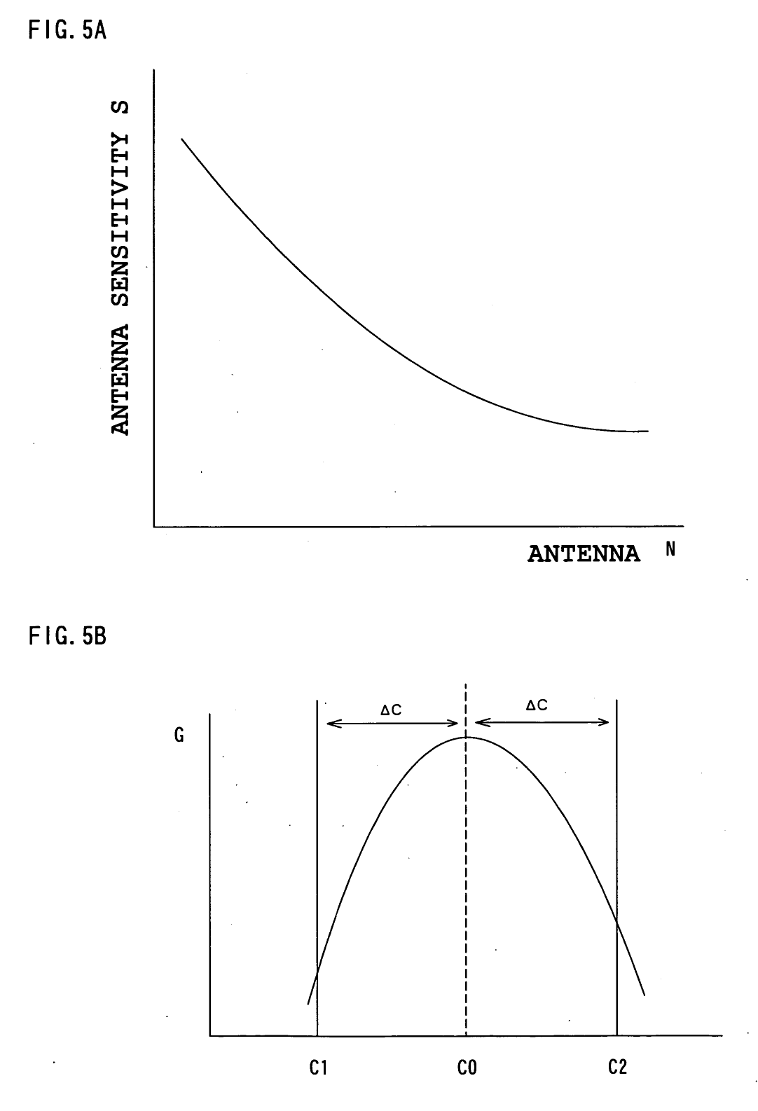

That is, as shown in FIG. 5B, gain or resonance output G is generally maximized at capacitance C0 at which a resonance condition is satisfied, and when capacitance is shifted from the resonance capacitance C0, the output G is decreased according to a level of the shift. Therefore, for example, assuming that the resonance capacitance C0 is a reference, considering variation that may occur during manufacturing, a capacitance approximately corresponding to capacitance that is smaller only by possibly maximum shift AC than the resonance capacitance, C1=C0−ΔC (C_{A1}≦C1 or C_{B1}≦C1), is selected as the capacitance C_{A1} or C_{B1} of the condenser for coarse adjustment K_{A1} or K_{B1}. While condensers in each group that belongs to the condenser group K_{A} or K_{B} are disposed in parallel and therefore the capacitance C1 at the lower limit is selected as the capacitance C_{A1} or C_{B1} of the condenser for coarse adjustment K_{A1} or K_{B1} in this example, when condensers for fine adjustment are connected in series, capacitance at an upper limit C2=C0+ΔC may be selected as the capacitance C_{A1} or C_{B1} of the condenser for coarse adjustment K_{A1} or K_{B1}. It is natural that C0−C1 and C2−C0 may be different in level. Since the condensers for fine adjustment K_{A2}, K_{A3} or K_{B2}, K_{B3} can be mounted on the surface side with margin, capacitance adjustment (replacement) of them can be easily performed, consequently accurate tuning can be achieved.

Once the lower limit value C1 has been secured by the capacitance C_{A1} or C_{B1} of the condenser for coarse adjustment K_{A1} or K_{B1}, then capacitance is adjusted such that it is close to C0 (of which the level is different between the condenser groups K_{A} and K_{B}) by the condensers for fine adjustment K_{A2}, K_{A3} or K_{B2}, K_{B3}. Here, since the capacitance C0 is not always equivalent to a designed value and may depend on various conditions for each of individuals, capacitance C_{A2}, C_{A3} or C_{B2}, C_{B3} depending on each of conditions can be added by the condensers for fine adjustment K_{A2,} K_{A3} or K_{B2}, K_{B3} to make the capacitance closer to the capacitance C0 that satisfies the resonance condition.

In the example, preferably, tuning on the condenser group K_{A} is carried out in the first, then tuning on a circuit portion including the condenser group K_{B} is carried out. However, if desired, wiring may be made such that the two portions can be perfectly independently tuned.

When all the condensers of the condenser groups K_{A} and K_{B}, that is, K_{A1}, K_{A2}, K_{A3} and K_{B1}, K_{B2}, K_{B3}, or part of condensers for fine adjustment K_{A2}, K_{B2} in addition to the condensers for coarse adjustment K_{A1}, K_{B1} may be previously prepared for a set of products such as a product lot having small individual difference, the condensers may be previously mounted for each of surfaces using means such as reflow.

The fact that length of the board 40 can be reduced makes it possible to increase length N of the antenna body 10, even if the arcuate space given to the antenna structure 3 is fixed. Generally, there is a relation as shown in FIG. 5A between the length N of the antenna body 10 and sensitivity S (dB) of the antenna body 10. The vertical axis indicates the sensitivity S (dB) in a decibel unit, wherein the sensitivity (dB) is improved with increase in antenna length N. Therefore, in the antenna structure 3, the length N of the antenna body 10 can be increased to a maximum within a range in which interference with other timepiece components does not occur, as a result reception sensitivity S (dB) of the antenna body 10 can be improved.

While description has been made assuming that each of the condenser groups K_{A}, K_{B} comprises three condensers in the above, each of the condenser groups K_{A}, K_{B} may comprise at least four condensers, and in that case, two or more condensers may be mounted at the side of the back 42.

While a case that two resonance frequencies are provided has been described in the above, the antenna structure can be desirably tuned to, for example, a standard wave having a transmission frequency of 70 KHZ in addition to, for example, two types of transmission frequencies 40 KHz and 60 KHz, which are the standard waves in Japan, so that it can be used even in foreign countries.

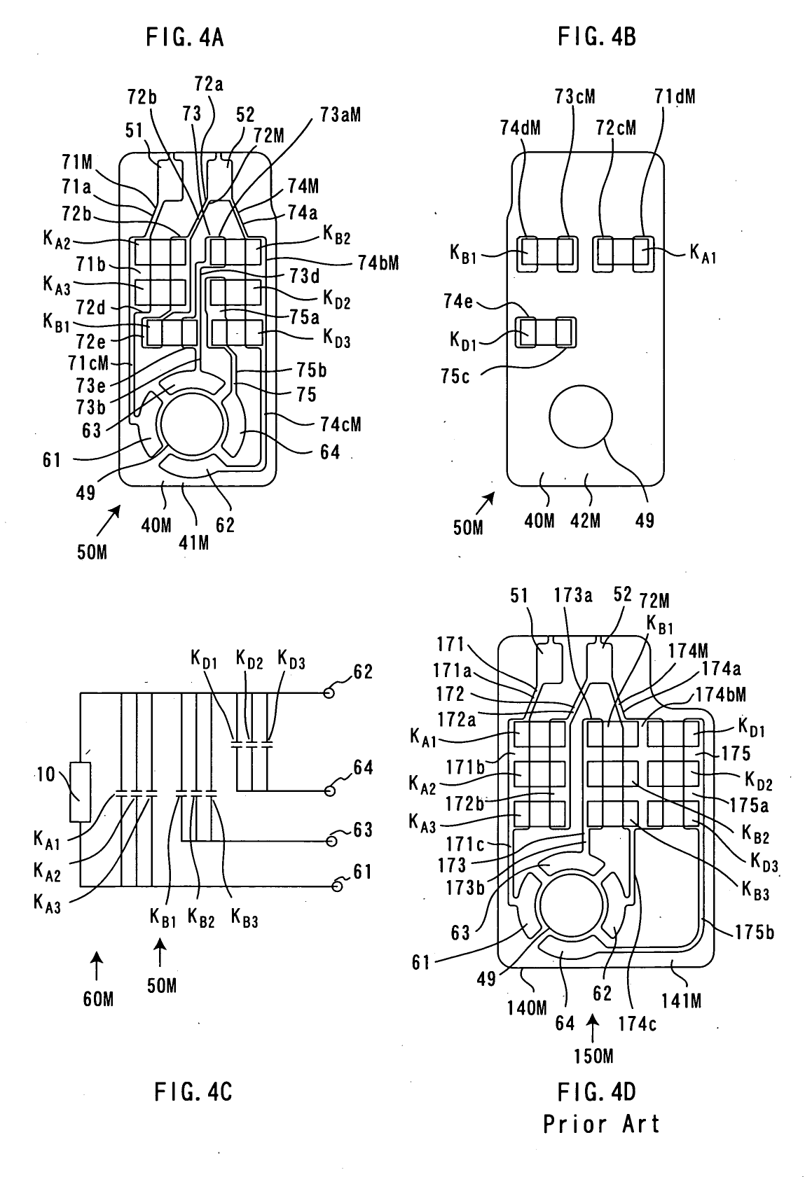

In FIGS. 4, a tuning circuit 60M including a circuit for tuning 50M, which can be tuned to each of the three types of transmission frequencies f1, f2 and f3, is shown. In FIG. 4, elements that are practically identical to those in the tuning circuit 60 including the circuit for tuning 50 of FIG. 3 are marked with identical signs, and element that are partially different from but corresponding to those are add with a subscript M.

In FIG. 4C, the tuning circuit 60M is schematically shown, and in the tuning circuit 60M, a condenser group K_{D} comprising condensers K_{D1}, K_{D2} and K_{D3} having capacitance of C_{D1}, C_{D2}, and C_{D3} and a corresponding output terminal 64 are further provided such that the circuit 60M can resonate with a standard wave having another transmission frequency. Again in this case, the condensers in the condenser group K_{D} satisfies a relation of capacitance of C_{D1}>C_{D2}>C_{D3}.

The circuit for resonance 50M that resonate with the three types of frequencies was traditionally in a mode of a circuit for resonance 150M having a condenser layout as shown in FIG. 4D. That is, the circuit for resonance 150M has wiring lines 171, 172 and 173 similarly as the circuit for resonance 50M as wiring, and has a wiring 174M having a contact formation part 174bM that is wide compared with the contact formation part 174b, and a wiring line 175 having a contact formation part 175a and an elongated wiring portion 175b. The contact formation part 175a of the wiring line 175 extends in parallel to the contact formation part 174bM outside the part 174bM. The wiring portion 175b is connected to a terminal at an output side 64. In the circuit for resonance 150M, the wiring lines are required to have large width as a whole, consequently width of a board 140M is large. All the condensers K_{D1}, K_{D2} and K_{D3} in the condenser group K_{D} are disposed in parallel at a side of a surface 141M between the contact formation part 174bM and the contact formation part 175a.

Here, when condensers K_{A1}, K_{B1} and K_{D1} as part of condensers in respective groups K_{A}, K_{B} and K_{D} (typically, condensers having maximum capacitance) are mounted at a back side according to the invention, they can be disposed in a position at which portions where condensers K_{A1}, K_{B1} and K_{D1} in the circuit for resonance 150M are disposed are overlapped at the back side with portions of condensers at the surface side (for example, condensers K_{A2}, K_{B2} and K_{D2}), therefore it will be clear that length can be reduced similarly as shown in comparison between FIG. 3D and FIGS. 3A, B, compared with the conventional circuit for resonance 150M in which all the condensers for resonance K_{A}, K_{B} and K_{D} are mounted at a side of one surface 141 as shown in FIG. 4D.

However, when the part of the condensers are mounted at the back side, the layout itself of the condensers at the surface side may by changed, and such an example is shown in FIG. 4A and FIG. 4B.

The circuit for resonance 50M shown in FIG. 4A and FIG. 4B, has, on the surface 41M of the board 40M, a wiring line 71M having a long wiring portion 71cM similarly as the wiring line 71; a wiring line 72M having a contact formation part 72e via an elongated wiring portion 72d extending obliquely from the end of the contact formation part 72b; a wiring line 73M comprising a contact formation part 73aM having a short contact formation part 73a, an elongated wiring portion 73d, and another short contact formation part 73e; a wiring line 74M that has a long contact formation part 74bM compared with the contact formation part 74b and a long wiring portion 74cM compared with the elongated wiring portion 74c and is connected to an output terminal 62 situated at an end side; and a wiring line 75 that has a contact formation part 75a that extends parallel to the contact formation part 73c and the contact formation part 74bM between them and an elongated wiring portion 75b, and is connected to an output terminal 64 situated on a side portion.

In the circuit for resonance 50M, in the surface 41M of the board 40M, a condenser K_{B2} is mounted between the contact formation parts 72e and 73e, a condenser K_{B3} is mounted between the contact formation parts 73aM and 74bM, and condensers K_{D2} and K_{D3} are mounted between the contact formation parts 75a and 74bM.

On the other hand, at a side of a back 42M of the board 40M, short contact formation parts 71dM, 73cM and 75c are formed in positions that are overlapped with positions of contact formation parts 71b, 72b, 73aM and 75a, and short contact formation parts 74dM and 74e are formed in positions that are overlapped with a position of the long contact formation part 74bM. The contact formation parts 74dM and 74e may be linked to each other. In the circuit for resonance 50M, at the side of the back 42M of the board 40M, the condenser for coarse adjustment K_{A1} is mounted between the contact formation parts 71dM and 72cM, the condenser for course adjustment K_{B1} is mounted between the contact formation parts 73cM and 74dM, and the condenser for course adjustment K_{D1} is mounted between the contact formation parts 75c and 74e.

In the circuit for resonance 50M configured in this way, since the condensers K are mounted at the side of the surface 41M in a manner of being arranged substantially in two lines, width is narrow compared with the circuit for resonance 150M of FIG. 4D that requires three line arrangement, consequently width of the board 40M can be narrowed. Again in this case, if desired, the condenser K for providing the capacitance for resonance C1 that can be roughly determined at the point of designing or sample manufacturing is previously incorporated as the condenser for coarse adjustment at the back side by reflow and the like, and for example, the condenser for fine adjustment can be mounted at the surface side after the board is mounted. In the case of this example, typically, the condensers for fine adjustment in the condenser group K_{A} are mounted, and then the condensers for fine adjustment in the condenser groups K_{B} or K_{D} are incorporated, as described before.

While description has been made in the above assuming that when the circuit for resonance comprises a plurality of channels (channel group), at least one condenser is mounted at the back side for any of the channels, in some cases, part of the condensers may be mounted at the back side for only a part of channels.

What is claimed is:

1. An antenna structure for wave timepiece, wherein condensers that perform tuning in cooperation with a coil of an antenna body are mounted on both of a surface and a back of a lead board disposed near a terminal of the antenna body.

2. An antenna structure according to claim 1, wherein a condenser for coarse adjustment is mounted at a side of the back of the lead board, and a condenser for fine adjustment is mounted at a side of the surface of the lead board.

3. An antenna structure according to claim 1, wherein the lead board comprises a thick board, and the condensers at the surface side and the back side are disposed in positions that are overlapped in a thickness direction of the board.

4. An antenna structure according to claim 1, wherein an antenna frame for receiving the antenna body has a recess in an end, and the condenser at the back side is received in the recess.

5. A wave timepiece having the antenna structure according to claim 1.
